(19) United States
(12) Patent Application Publication
(10) Pub. No.: US 2026/0243374 A1
(43) Pub. Date: Aug. 20, 2026

(54) THERMOPLASTIC PVC HOSE FOR SEVERE COLD SERVICE

(71) Applicant: ContiTech Deutschland GmbH, Hannover (DE)

(72) Inventors: Naveed Khan, Mount Pleasant, IA (US); Flint Wilson, Mount Pleasant, IA (US); Guangzhuo Rong, Hudson, OH (US)

(73) Assignee: ContiTech Deutschland GmbH, Hannover (DE)

(21) Appl. No.: 19/056,605

(22) Filed: Feb. 18, 2025

(51) Int. Cl. F16L 11/08

(52) U.S. Cl. CPC F16L 11/08; F16L 11/081; F16L 11/085

(57) ABSTRACT

A cold service hose includes a tubular layer formed from a polyvinyl chloride (PVC) composition having: (a) PVC polymer(s) in a total amount of at least 70 phr; (b) adipate plasticizer(s) in a total amount from 50 phr to 85 phr, including dioctyl adipate (DOA) plasticizer(s) constituting a majority by weight of the adipate plasticizer(s); and (c) non-adipate plasticizer(s) from 0 phr to 30 phr. A total plasticizer content of the PVC composition is in a range from 70 phr to 110 phr; a total phr of the PVC composition is from 170 phr to 210 phr; and the PVC composition does not contain more than 20 phr of other ingredient(s) in total combination. The PVC composition exhibits cold-temperature embrittlement resistance by not cracking when bent at temperatures of at least −65 F or colder as tested in accordance with ASTM D380.

### TECHNICAL FIELD

The present disclosure relates generally to a thermoplastic polyvinylchloride compound, particularly for hoses, and more particularly to thermoplastic PVC hose for severe cold service.

### BACKGROUND

Thermoplastic hoses are used in a variety of applications for transporting fluids such as liquids and gases. In certain severe service applications, polyvinylchloride (PVC) can be used to maintain flexibility and performance at temperatures as low as −65° F. Such a hose construction may include a reinforcement layer to enhance durability and pressure tolerance. The reinforcement layer may include filaments arranged in a braided or spiral configuration, or the reinforcement may include a rigid thermoplastic material helically incorporated along a length of the hose.

### SUMMARY

At least one problem with conventional PVC hose used in severe cold service applications is that the service temperature may be limited to −65° F. or warmer to maintain suitable performance, including flexibility without cracking. There is therefore a need for a severe cold service hose that can attain lower service temperatures.

At least one aspect of the present disclosure solves one or more problems associated with conventional severe cold service hose by providing a PVC material that can have suitable embrittlement resistance to maintain flexibility without cracking at temperatures colder than −65° F., such as a embrittlement resistance as low as −80° F., or even as low as −100° F. without cracking.

According to an aspect, a hose includes at least one tubular layer formed from a polyvinyl chloride (PVC) composition, the composition including: (a) one or more base polymer(s) present in a total amount of 100 phr, the base polymer(s) including one or more PVC polymer(s), the PVC polymer(s) being present in a total amount of at least 70 phr; (b) one or more adipate plasticizer(s) present in a total amount from 50 phr to 85 phr, the adipate plasticizer(s) including one or more dioctyl adipate (DOA) plasticizer(s), the DOA plasticizer(s) constituting a majority by weight of the adipate plasticizer(s); and (c) one or more non-adipate plasticizer(s) in a total amount from 0 phr to 30 phr; wherein a total plasticizer content of the PVC composition, including (b) the adipate plasticizer(s) and (c) the non-adipate plasticizer(s) when present, is in a range from 70 phr to 110 phr; wherein a total phr of the PVC composition, including (a) the base polymer(s), (b) the adipate plasticizer(s), and (c) the non-adipate plasticizer(s) when present, is from 170 phr to 210 phr; wherein the PVC composition does not contain more than 20 phr of one or more other ingredient(s) in total combination, the other ingredient(s), when present, excluding (a) the base polymer(s), (b) the adipate plasticizer(s), and (c) the non-adipate plasticizer(s); and wherein the PVC composition exhibits cold-temperature embrittlement resistance by not cracking when bent at temperatures of at least −65 F or colder as tested in accordance with ASTM D380.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various aspects according to the present disclosure.

FIG. 1 shows an exemplary embodiment of a hose according to the present disclosure.

FIG. 2 shows another exemplary embodiment of a hose according to the present disclosure.

FIGS. 3A and 3B are graphs of test data showing Tan Delta versus Temperature.

FIGS. 4A and 4B are graphs of test data showing G′ versus Temperature.

FIGS. 5A and 5B are graphs of test data showing G″ versus Temperature.

### DETAILED DESCRIPTION

The principles and aspects according to the present disclosure have particular application to hoses, in particular cold service fluid transfer hoses such as for gas and liquid, and thus will be described herein mainly in this context. It is understood, however, that the principles and aspects of the present disclosure may be applicable to other types of hoses for other applications, or to other articles in general, when desirable to provide one or more advantages of the material(s) and/or construction(s) described herein.

Aspect(s) according to the present disclosure provide a PVC-based composition and/or an article construction using such a PVC-based composition, in which the composition uses a unique amount and/or combination of plasticizer(s) in conjunction with other ingredients that enable the PVC-based composition to have a low embrittlement temperature and thus have suitable performance, including flexing without cracking, at temperatures colder than −65° F., more particularly as cold as −80° F. or colder, such as down to −100° F.

Generally, the exemplary PVC-based composition may be used in a reinforced article with at least one reinforcement incorporated with the PVC-based composition.

According to certain aspects, the unique PVC-based composition at least partially or wholly forms at least one tubular layer of a hose which is suitable for use in severe cold service applications, such as those colder than −65° F.

### Composition

The exemplary PVC-based composition includes at least one base PVC polymer and a plasticizer package that includes at least one adipate plasticizer in a relatively high amount relative to other plasticizer(s) and/or relative to the overall composition for providing low temperature performance. The exemplary PVC composition also may contain one or more of the following additional ingredients: one or more additional plasticizer(s); one or more stabilizer(s); and one or more processing aid(s). The exemplary composition may include additional suitable functional ingredient(s) to achieve desired chemical, mechanical, thermal, or other material performance properties and/or optionally include additional suitable non-functional ingredient(s) to provide desired aesthetic or ancillary characteristic(s). Non-functional additives/ingredients intentionally incorporated primarily for aesthetic or ancillary purposes are distinguished from the functional ingredients/additives listed above because they do not modify the chemical, mechanical, thermal, or other material performance properties of the composition in a meaningful way, nor do they meaningfully enhance processing characteristics in the way that functional processing aids, such as internal lubricants, do when admixed into the material. Examples of non-functional additives include, but are not limited to, colorants, pigments, dyes, or the like. Certain additives/ingredients, like inert fillers, may be considered functional or non-functional depending on whether they meaningfully contribute to the mechanical, thermal, or other performance characteristics of the material when incorporated therein, as understood by those having ordinary skill in the art.

Suitable functional ingredients of the exemplary PVC-based composition (also referred to herein as the PVC composition or PVC compound) will be described in further detail below for sake of clarity and not limitation, it being understood that certain embodiments may provide different suitable combinations of these ingredient types and/or amounts, may include one or more additional ingredients or alternative equivalent ingredients in any suitable combination, or may specifically eliminate one or more of these ingredients in any suitable combination, as would be understood by those having ordinary skill in the art in view of the teachings provided herein. These additives/ingredients may be listed under certain headings, sub-headings or paragraphs, which is done solely for organization and not limitation, it being understood that certain ingredients may have different functions or multiple functions depending on the type and/or amount incorporated into the composition, in conjunction with the other ingredient(s), as understood by those having ordinary skill in the art. Accordingly, the listing of an additive/ingredient under a heading for one class of material does not necessarily preclude its use under another class of material for a different function, unless expressly stated to the contrary.

The exemplary PVC-based composition includes one or more PVC polymer(s) that form at least part of the matrix and serve as a base of the PVC composition. The composition also may contain other polymer(s) that are blended with the base PVC(s) to also form part of the matrix of the composition. The total polymer content forming the base composition (which may include mixtures of base polymers) is set at 100 phr. The polymer matrix of the PVC-based composition generally will be formed from a majority of PVC polymer(s) as opposed to other types of base polymer(s), and thus the PVC(s) may constitute 50% or more by weight of the overall base polymer content, more particularly 70%, 80%, 90%, or more. The additives in the composition are compounded relative to the total base polymer content of the composition, and as such may be represented in parts per hundred (phr), which means parts by weight per 100 parts by weight of the base polymer(s).

The thermoplastic PVC compound may include one or more of the PVC polymer(s) in a total amount from about 70 parts per hundred (phr) to about 100 phr, more particularly from about 80 phr to about 100 phr, such as about 70, 75, 80, 85, 90, 95 or 100 phr (including all values between the stated values, and all ranges and subranges between such values). The PVC polymer(s) may be polyvinylchloride homopolymer resins. The PVC polymer(s), or blends thereof, may have any suitable molecular weight or intrinsic viscosity for the particular application, including the final material properties for the application or processing properties for making the product of the application. For example, the PVC resin, or blends thereof, may have an intrinsic viscosity as measured by the Fikentscher K value in a range from about K65 to about K80, more particularly in a range from about K65 to about K75 (including all values and subranges between such values). The K-value is a unitless empirical measure closely related to intrinsic viscosity, often defined in slightly different ways in different industries to express viscosity-based estimate of statistical molecular mass and average degree of polymerization of polymeric material used particularly for PVC. A commonly used K value in Europe is the Fikentscher K value (referenced in DIN EN ISO 1628-1) obtained by dilute solution viscometry and solving Fikentscher equation. The K-value generally correlates to the molecular weight of the PVC resin, such that higher K-values indicate higher molecular weight PVC (and thus greater strength), while lower K-values represent lower molecular weight PVC.

The PVC-based composition also includes a plasticizer package that increases the flexibility of the composition, thereby transforming the relatively rigid thermoplastic nature of PVC into a thermoplastic elastomer like composition, even without elastomer(s) in the composition (according to exemplary embodiments). More particularly, the plasticizer package includes one or more plasticizer(s) that contribute to the severe cold performance of the PVC compound to enable it to have exceptional cold temperature embrittlement resistance to operate with flexibility and without failure (cracking) at temperatures colder than −65° F., more particularly as cold as −80° F. or colder, such as down to −100° F.

In exemplary embodiments, the plasticizer package includes at least at least one adipate plasticizer which is present in the PVC compound in a total amount from about 50 phr to about 85 phr, more particularly from about 70 phr to about 85 phr, such as about 50, 60, 70, 75, 80, or 85 phr (including all values between the stated values, and all ranges and subranges between such values). The at least one adipate plasticizer used in the foregoing amounts may be of any suitable type, which may include, for example, dioctyl adipate (DOA), diisodecyl adipate (DIDA), diisononyl adipate (DINA), polymeric adipates (polyadipates), or the like, or mixtures thereof.

In exemplary embodiments, the at least one adipate plasticizer used in the foregoing amount(s) includes at least one DOA. In certain embodiments, the at least one DOA plasticizer is a major contributor to the overall amount of the adipate plasticizer(s) to significantly improve cold performance at very cold temperatures. As such, the DOA plasticizer(s) may constitute 50% or more by weight of the overall adipate plasticizer content, more particularly 70% or more, such as 50, 60, 70, 80, 90 or 100% (including all values between the stated values, and all ranges and subranges between such values). In exemplary embodiments, the only adipate plasticizer used in the composition is DOA, which contributes exceptional cold performance to the composition.

The plasticizer package also may include non-adipate plasticizer(s) in addition to the adipate plasticizer(s) to work in conjunction therewith. The additional plasticizer(s) may be of any suitable type for the PVC composition. In exemplary embodiments, the additional plasticizers include at least one additional non-phthalate plasticizer. Suitable non-adipate/non-phthalate plasticizers include terephthalates such as dioctyl terephthalate (DOTP), cyclohexane dicarboxylates such as diisononyl cyclohexane-1,2-dicarboxylate (DINCH), trimellitates such as tris(2-ethylhexyl) trimellitate (TOTM), citrates such as acetyl tributyl citrate (ATBC), triethyl citrate (TEC), and butyryl trihexyl citrate (BTHC), epoxidized oils such as epoxidized soybean oil (ESO) and epoxidized palm oil (EPO), benzoates and glycol benzoates such as diethylene glycol dibenzoate (DEGDB) and triethylene glycol dibenzoate (TEGDB), and polymeric plasticizers such as polyadipates and polyester plasticizers. Notably DOTP (dioctyl terephthalate) is not considered a phthalate plasticizer because it is an ester derived from terephthalic acid, rather than from ortho-phthalic acid like DEHP, DINP, or other traditional “phthalates.”

The non-adipate additional plasticizer(s) may be present in the PVC composition in a total amount of up to about 30 phr, more particularly from about 0 phr to about 20 phr, such as 0, 5, 10, 15, 20, 25, or 30 phr (including all values between the stated values, and all ranges and subranges between such values). In exemplary embodiments, the PVC composition has non-adipate/non-phthalate additional plasticizer(s) consisting of one or more terephthalate(s) (e.g., DOTP) and/or one or more cyclohexane dicarboxylate(s) (e.g., DINCH), which is/are present in the total amount stated above. In exemplary embodiments, the only non-adipate/non-phthalate plasticizer present is one or more terephthalate(s), and more particularly DOTP(s), within the amount(s) specified above.

To further improve the sub-freezing performance properties of the PVC compound, the adipate plasticizer(s), and in particular the DOA(s), are present in a greater total amount than the total amount of all other (non-adipate) plasticizer(s). In exemplary embodiments, the total content of all plasticizer(s) in the composition is in a range from about 70 phr to about 110 phr, and the adipate plasticizer(s) may constitute >50%, such as 55, 60, 70, 80, 90, or 100% by weight of the overall plasticizer content (including all values between the stated values, and all ranges and subranges between such values). Based on the foregoing range values described above, this may result in a phr ratio of the total adipate plasticizer(s) relative to the total of all other (non-adipate) plasticizer(s) in a range from about 50:20 to about 85:30, more particularly from about 50:30 to about 85:0, even more particularly from about 70:20 to about 85:0, including all values between the stated values, and all ranges and subranges between such values.

Because PVC is thermally sensitive, the PVC compound may include one or more stabilizers. The total amount of stabilizer(s) may be present in the PVC compound in a total amount of up to about 20 phr, more particularly up to about 10 phr, more particularly up to about 5 phr, such as in a range from about 1 phr to about 10 phr (including all values between the stated values, and all ranges and subranges between such values). In certain embodiments, beyond about 10 phr stabilizer may have minimal stabilization effect and may detrimentally affect cold performance of the compound. Any suitable stabilizer or combination of stabilizers may be used in the PVC compound. For example, suitable stabilizers may include a metal-based stabilizers that neutralize HCl generation, which may include calcium zinc, barium zinc, or the like. Such stabilizers may be present in a total amount from about 1 phr to about 5 phr, more particularly up to about 2.5 phr. Secondary stabilizers such as epoxidized soybean oil (ESO) also may be added, which may be present in a total amount of up to about 5 phr, such as about 1 to 5 phr.

Additional additives, such as processing aids also may be included in the PVC compound. For example, stearic acid may be used to improve processability of the PVC compound by enhancing flowability of the material and aid in the dispersion of other compounding ingredients. In exemplary embodiments, the stearic acid may be provided in the PVC compound in a total amount from about 0.1 phr to about 0.5 phr, such as about 0.3 phr.

To further enhance cold performance in sub-freezing temperatures, the PVC composition may have a rather limited range of additives other than the base polymer(s) (e.g., PVC-base) and plasticizer(s), as it is understood that too much additional ingredients may cause embrittlement at temperatures of less than −65 F, more particularly −80 F or less. Accordingly, in exemplary embodiments, the PVC composition may have a total phr content of all ingredients of at least 170 phr to permit sufficient plasticizer(s) in addition to the base polymer(s), yet may be limited to no more than 210 phr total phr to limit the total amount of ingredient(s). More particularly, the exemplary PVC composition may have no more than 20 phr of any additive other than base polymer and plasticizer is present in the PVC composition. In view of the exemplary ingredients and amounts described above, certain embodiments of the PVC composition may have 100 phr of base polymer(s) (>50% PVC) and up to 115 phr of total plasticizer(s) (of which adipate plasticizer(s) constitute 50 to 85 phr of this total), resulting in 215 phr, with a 20 phr maximum of additional ingredients, but with a limit of 210 phr, the total phr of the PVC compound is in a range from about 170 phr to about 210 phr. If, on the hand, the exemplary PVC compound has 100 phr base polymer(s) (>50% PVC) and up to 85 phr of total plasticizer(s) (of which adipate plasticizer(s) constitute 50 to 85 phr of this total), the result is 185 phr; thus, with a 20 phr maximum of additional ingredients, the total phr of this PVC compound may be in a range from about 170 phr to about 205 phr. In certain embodiments, the exemplary PVC composition consists of only base polymer(s), plasticizer(s), stabilizer(s), and optionally processing aid(s) in the type(s) and amount(s) described above to achieve the overall phr range as stated. In specific embodiment(s), the functional ingredients of the PVC composition consists essentially of PVC polymer, DOA plasticizer, DOTP plasticizer, stabilizer (e.g., ESO and/or metal stabilizer), and optionally a processing aid in the stated total phr range(s). As discussed above, the PVC compound exhibits exceptional embrittlement resistance at extreme sub-freezing temperatures, such as below −65 F or even as cold as −80 F, or even down to −100 F, without cracking under flexure.

### Article Embodiments

Certain article embodiments of the disclosure will hereafter be described with reference to the accompanying drawings, in which like reference numerals denote like elements. It should be understood, however, that the accompanying figures illustrate the various implementations described herein and are not meant to limit the scope of various technologies described herein. In addition, it is understood that various aspects and features of these embodiments may be substituted for one another or used in conjunction with one another where applicable. Furthermore, it is understood that the description of material(s) forming the various parts of one embodiment article may be the same material(s) for the same or similar part in another embodiment article, except as otherwise noted below.

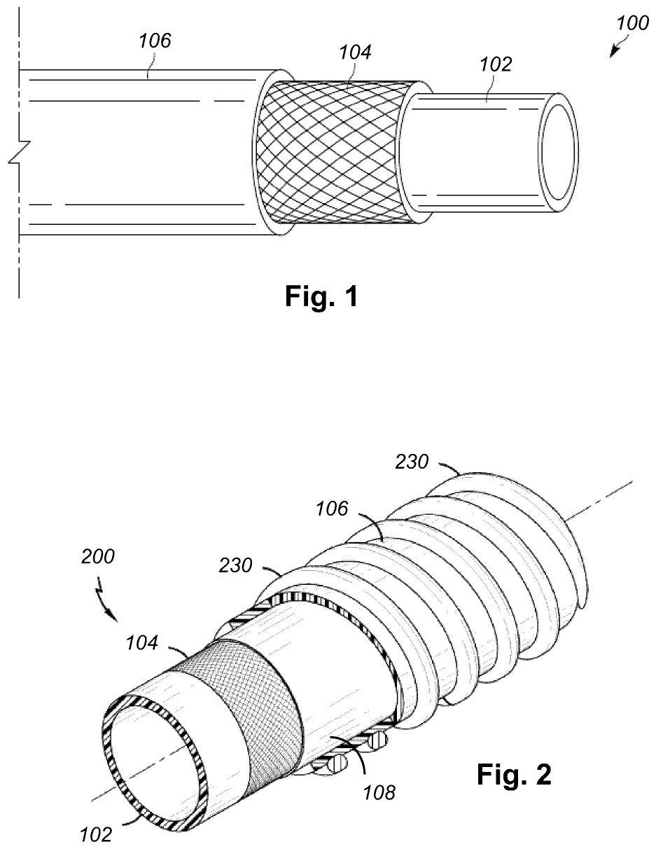

FIGS. 1 and 2 illustrate exemplary embodiments of hoses 100, 200 according to the present disclosure. As shown, the exemplary hoses 100, 200 may include at least an inner tube layer 102, a reinforcement layer 104, and an outer cover layer 106. One or more of these layers 102, 104 and 106 may be formed from or incorporate the exemplary PVC-based composition described herein. Generally, to provide advantages of the exemplary PVC-based composition described herein, an entirety of the inner tube 102 and the outer tube 106 may be formed by the PVC-based composition. Variations in the PVC-based composition may be made between the composition of the inner tube 102 and outer cover layer 106 so that these layers have a different composition, which may depend on the requirements. Such variations generally may be in accordance with the different materials and/or ranges described above.

In certain embodiments, the inner diameter, outer diameter, and thickness of the differing layers of the hose may be as desired for achieving the characteristics of the hose for the particular application(s). For example, exemplary hoses may have an inside diameter which is within the range of about 0.5 inch (12.7 mm) to about 4 inches (about 100 mm) and an outside diameter of about 1 inch (25.4 mm) to about 6 inches (about 150 mm). The overall wall thickness of the hose including all layers may be within a range from about 0.10 inch (2.5 mm) to about 0.4 inch (10 mm) or more. The wall thickness of the inner tube 102 may be in a range from about 0.02 inch (0.5 mm) to about 0.16 inch (4 mm), more particularly from about 1 mm to about 3 mm. The wall thickness of the outer tube 106 may be in a range from about 0.04 inch (1 mm) to about 0.12 inch (3 mm).

Referring in detail to FIG. 1, hose 100 includes at least an inner tube layer 102, reinforcement layer 104, and cover layer 106. The inner tube layer 102 of the hose is often the innermost layer that forms the internal fluid passage, or lumen, of the hose and comes into contact with the fluid being conveyed. This tubular inner layer may be referred to simply as the “tube,” or as the “core.”

The reinforcement layer 104 provides additional strength to the hose, typically by incorporating filaments of reinforcement into the hose, such as around the tube layer 102 or an intermediate layer (not shown). The reinforcement filaments may have any suitable configuration or combination of configurations, and the reinforcement filaments may be made of any suitable material or combination of materials for reinforcing the hose. The reinforcement layer 104 may include one or more layers of such filaments, which these reinforcement sub layers may be directly radially adjacent to each other and/or may be separated by intervening layer(s) of material (e.g., rubber layer between reinforcement sub layers).

The reinforcement filaments may include elongated fibers, threads, wires, bands, or the like, or mixtures thereof, which may be in monofilament or multi-filament form. The individual filaments may be grouped together to form bundles, strands, tows, yarns, cords, or the like. Generally, a tow or strand may be a bundle of untwisted individual filaments, a yarn may be a bundle of twisted or cabled individual filaments, and a cord may be bundle of twisted, braided, or cabled yarns/strands or bundle of yarns/strands plied together into a thicker, stronger form. The individual filaments or grouping of filaments (e.g., strands, yarns, cords) may be arranged in a spiral, braided, knitted, fabric, or wrapped reinforcement construction. In some embodiments, the hose may include one or more of these layers of reinforcement, and each layer may have a different orientation of its filament arrangement. For example, where two or more layers of spiral reinforcement may be used, a first layer may have strands/yarns/cords spiral wound in a first winding direction, and a second layer may have strands/yarns/cords spiral wound in a second winding direction opposite the first winding direction. A braided configuration may include groupings of filaments (e.g., strands, yarns, cords) arranged in a 1-over, 1-under braid pattern, a 3-over, 3-under braid pattern, or a 4-over, 4-under braid pattern, or the like.

The reinforcement material of the filaments may include, but is not limited to, metal, synthetic or natural material, or mixtures thereof. For example, the reinforcement filaments may be metal wire (such as steel wire, stainless-steel wire, plated-steel wire, plain steel wire, or the like). Synthetic materials may include nylon, vinylon, aramid, rayon, polyester (such as polyethylene terephthalate or polyethylene naphthalate), polyvinyl acetate, polyvinyl alcohol (PVA), poly p-phenylene-2,6-benzobisoxazole (PBO), polypropylene, polyamide, carbon fiber, or the like. Natural, ceramic, mineral, etc. fibers may include cotton, jute, hemp, basalt, glass, or the like. For a severe cold service hose that is used in sub-freezing temperatures, the reinforcement filaments may be formed from synthetic materials such as PET.

The cover layer 106 is located outwardly of the reinforcement layer 104 and serves to protect the inner layers from the environment of the hose when deployed for use in the field. The cover layer 106 may have any suitable configuration and be made of any suitable material. Several factors may be used to determine the construction and/or materials selection for the cover layer, including but not limited to abrasion resistance, chemical resistance, economy, formability, aesthetics, or the like. In exemplary embodiments, the cover layer 106 has the same PVC-based composition as the inner tube layer, which may account for minor variations such as for pigmentation/coloring or different visual appearance.

The hoses 100, 200 may be produced by forming the tubular layers according to known processes. For example, the inner tube 102 may be extruded, such as on a mandrel. Then the reinforcement layer 104 may be applied with any of the arrangement described above. The outer cover layer 106 then covers the reinforcement layer 104, such as by extrusion, winding or the like, so as to bond the layers of the hose integrally.

FIG. 2 illustrates another exemplary embodiment of a hose 200 in which at least one tubular layer, such as layer(s) 102, 108, and/or 106 are formed from the exemplary PVC-based composition described above. As shown in FIG. 2, the outer cover layer 106 may have at least one helically wound reinforcing strip 230 which is at least partially embedded within the outer cover layer 106; or co-formed in an alternating pattern with the cover layer 106. Each of the reinforcement strip(s) 230 may include a plurality of continuous coils or turns, that are wound with a spiral or helical winding pattern having a pitch such that adjacent turns are spaced apart from each other in the longitudinal direction. The strip(s) 230 may be formed from a material having a higher modulus than the material of the cover layer 106 to impart greater rigidity and an anti-kinking nature to the hose 200. For example, the strip(s) 230 may be formed from a PVC material (or other suitable material) having a greater molecular weight and/or modulus than the molecular weight and/or modulus of the PVC material of the cover layer 106. As such, the strip(s) 230 may be formed from a PVC having a higher rigidity than the PVC of the cover layer 106. The strip(s) 230 may be manufactured using known extrusion or other process(es) applied to the cover layer 106; or the strips 230 may be co-extruded in an alternating pattern with the material of the cover layer 106 to form an integral cover layer. In this manner, the outer cover layer 106 of hose 200 may include spiral or helically wound strips 230, or segments 230, of higher modulus material that are axially spaced apart, with regions of lower modulus material at least between strips or segments. In some embodiments, another layer (not shown) may be applied over the strips 230 and layer 106 to form the overall cover layer.

It is understood that the hose 200 may be configured differently than that shown in FIG. 2 to have fewer or additional layers. For example, in alternative embodiments, the hose 200 may have the cover layer 106 as the only tubular layer (also 106) that defines the internal lumen of the hose 200. In such an embodiment, the tubular layer 106 may be formed from the exemplary PVC-based composition described above, and the reinforcing strip(s) 230 may be formed from another more rigid polymer, such as a more rigid PVC like that described above, to provide a reinforcing effect.

### Examples

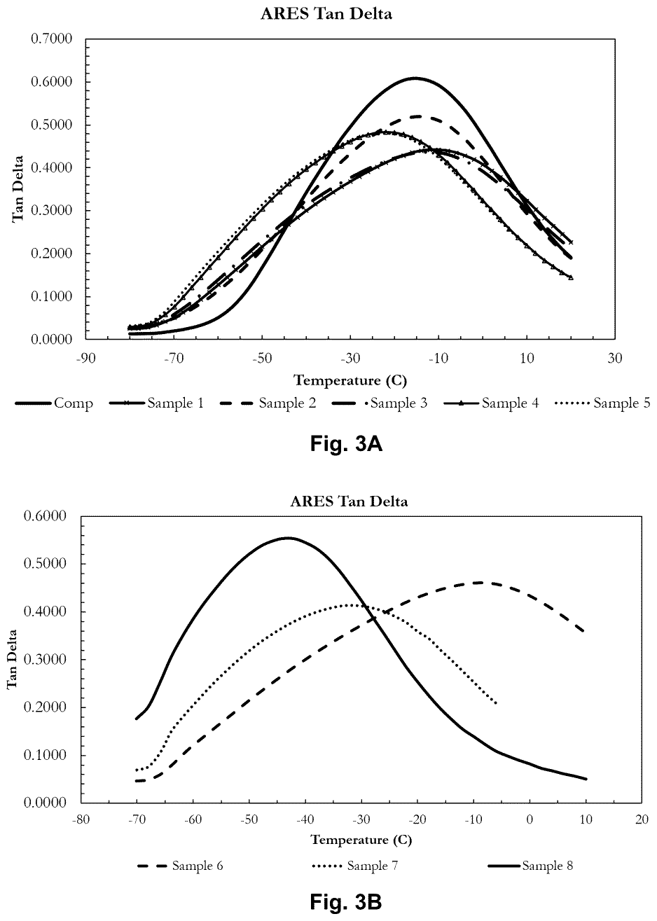

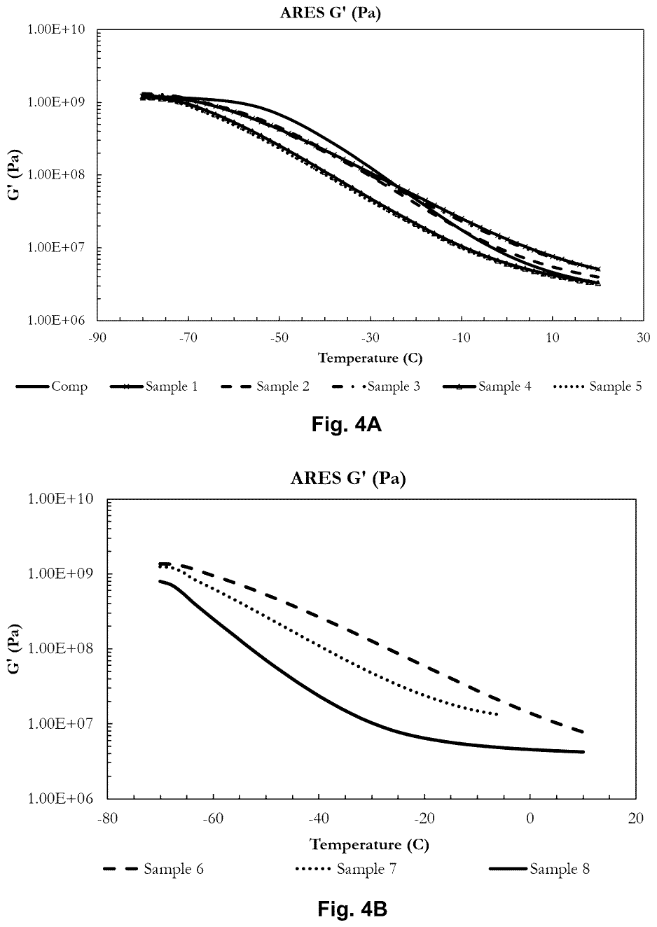

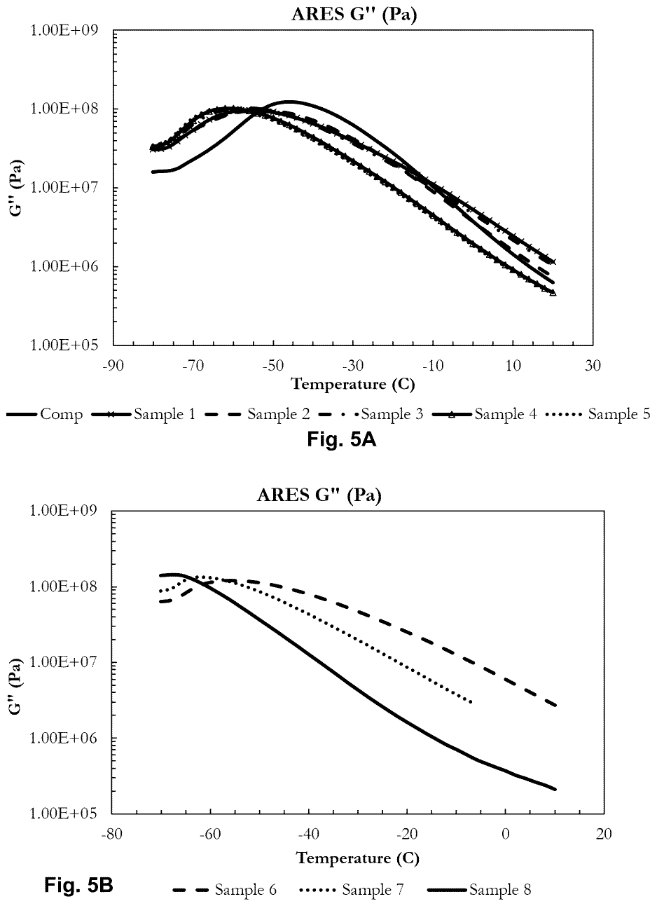

Examples were prepared and tested for the purpose of further illustrating the nature of some of the embodiments and aspects of the disclosure and are not intended as a limitation on the scope thereof. These examples are shown in Table 1 and results are shown in FIGS. 3A-5B.

TABLE 1

| | Sample | Sample | Sample | Sample | Sample | Sample | Sample | Sample |
|---|---|---|---|---|---|---|---|---|
| | 1 | 2 | 3 | 4 | 5 | 6 | 7 | 8 |
| PVC base | 100 | 100 | 100 | 100 | 100 | 100 | 100 | 100 |
| polymer | | | | | | | | |
| DOA | 40 | 40 | 45 | 50 | 55 | 60 | 70 | 80 |
| plasticizer | | | | | | | | |
| DOTP | 40 | 0 | 35 | 30 | 25 | 20 | 10 | 0 |
| plasticizer | | | | | | | | |
| TOTM | 0 | 40 | 0 | 0 | 0 | 0 | 0 | 0 |
| plasticizer | | | | | | | | |
| ESO | 5 | 5 | 5 | 5 | 5 | 5 | 5 | 5 |
| stabilizer | | | | | | | | |
| Calcium Zinc | 2.5 | 2.5 | 2.5 | 2.5 | 2.5 | 2.5 | 2.5 | 2.5 |
| stabilizer | | | | | | | | |
| PHR Total | 187.5 | 187.5 | 187.5 | 187.5 | 187.5 | 187.5 | 187.5 | 187.5 |

The results in FIGS. 3A-5B show various curves of dynamic mechanical analysis of Samples 1-8 as measured against a control sample which is a commercially available PVC compound. This testing was performed in accordance with ASTM D5992. These results generally demonstrate that relatively low amounts of adipate plasticizer (e.g., DOA) of less than 50 phr, with a total plasticizer content of 80 phr, had tan delta peaks of around −15 deg C. or warmer (e.g., Samples 1-3); whereas adipate plasticizer (e.g., DOA) of 50 phr or greater, with a total plasticizer content of 80 phr, had tan delta peaks of around −20 deg C. or colder (e.g., Samples 4-8), of which this tan delta peak is understood to correlate to improved cold temperature embrittlement. Generally, as the adipate plasticizer (e.g,. DOA) content increases relative to total plasticizer content, the tan delta curve continues to decrease, such as a peak of about −30 C or less (Sample 7), or about −40 C to −45 C (Sample 8).

To further test the effect of cold temperature performance, an exemplary hose using the construction shown in FIG. 1 with the formulation in Sample 8 as the inner tube layer and the outer tube layer, and with a spiral wound PET reinforcement layer, was cold bend tested according to ASTM D380. This hose did not exhibit cracking (embrittlement) when flexed at temperatures of −65 F, −70 F, −75 F, −80 F, −85 F, −90 F, and −100 F. This hose construction (with Sample 8 material) also was compared against a commercially available hose, in which the results demonstrated that at −65 F, the commercially available hose had a force to bend about a 6-inch mandrel of 18.9 lbf, and the exemplary hose was able to be bent about the 6-inch mandrel with a force of 14.2 lbf, demonstrating about a 25% improvement of the flexibility of the hose at −65 F.

According to an aspect, a hose includes at least one tubular layer formed from a polyvinyl chloride (PVC) composition, the composition including: (a) one or more base polymer(s) present in a total amount of 100 phr, the base polymer(s) including one or more PVC polymer(s), the PVC polymer(s) being present in a total amount of at least 70 phr; (b) one or more adipate plasticizer(s) present in a total amount from 50 phr to 85 phr, the adipate plasticizer(s) including one or more dioctyl adipate (DOA) plasticizer(s), the DOA plasticizer(s) constituting a majority by weight of the adipate plasticizer(s); and (c) one or more non-adipate plasticizer(s) in a total amount from 0 phr to 30 phr; wherein a total plasticizer content of the PVC composition, including (b) the adipate plasticizer(s) and (c) the non-adipate plasticizer(s) when present, is in a range from 70 phr to 110 phr; wherein a total phr of the PVC composition, including (a) the base polymer(s), (b) the adipate plasticizer(s), and (c) the non-adipate plasticizer(s) when present, is from 170 phr to 210 phr; wherein the PVC composition does not contain more than 20 phr of one or more other ingredient(s) in total combination, the other ingredient(s), when present, excluding (a) the base polymer(s), (b) the adipate plasticizer(s), and (c) the non-adipate plasticizer(s); and wherein the PVC composition exhibits cold-temperature embrittlement resistance by not cracking when bent at temperatures of at least −65 F or colder as tested in accordance with ASTM D380.

Exemplary embodiment(s) may include the foregoing aspect(s) in combination with one or more of any of the foregoing additional features described above and/or one or more of any of the following additional features in the appended claims, in which one or more of these additional features may be combined separately or in any suitable combination with each other.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

Use of “a” or “an” are employed in this disclosure to describe elements and components of the embodiments herein. This is done merely for convenience and to give a general sense of concepts according to the disclosure. This description should be read to include one or at least one and the singular also includes the plural unless otherwise stated.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The phrases “at least one of [A], [B] and [C];” “at least one of [A], [B] or [C];” “one or more of [A], [B] and [C]”; or “one or more of [A], [B] or [C]” are all synonymous with the phrase “and/or” and are used to mean “one, or more, or all” unless clearly indicated to the contrary. Thus, as a non-limiting example, this could mean (1) A only, (2) B only, (3) C only, (4) A and B, (5) A and C, (6) B and C, or (7) all of A, B and C. Other elements may optionally be present other than the elements specifically identified whether related or unrelated to those elements specifically identified unless clearly indicated to the contrary—e.g., by reciting a closed group of alternatives, such as via conventional “Markush grouping” by stating “selected from the group consisting of [A], [B], and [C].”

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

The example(s), if any, are for the purpose of illustrating the nature of some of the embodiment(s) and/or aspect(s) of the present disclosure and are not intended as a limitation on the scope thereof. Along these lines, such example(s) may include exemplary ingredients according to certain embodiment(s) of the present disclosure, and also may specifically exclude certain other ingredient(s) according to certain embodiment(s) of the present disclosure. Therefore, it is to be understood that the listing of certain ingredient(s) or class(es) of ingredients in the disclosure which are absent in the example(s) of the disclosure can mean an express exclusion of such ingredient(s) or class(es) of ingredients as if explicitly stated such that the inventor(s) have possession of such exclusion(s). It is understood, of course, that the absence of ingredient(s) according to certain embodiment(s) illustrated in the example(s) is not a limitation on all embodiment(s) of the disclosure, and so some embodiment(s) may include the absent ingredient(s), unless clearly indicated to the contrary.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated, and thus these values are incorporated herein by reference. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) have possession of the entire range and all points within the range, which are hereby incorporated herein by reference.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, 10%, 9%, 8%, 7%, 6%, 5%, 4%, 3%, 2%, 1%, 0.01%, or 0.0% of the stated value, as well as values intervening such stated values. When the term “about” is used in describing a value or an end-point of a range, the disclosure should be understood to include the specific value or end-point referred to.

The term weight percent in relation to a component of the composition is understood to mean weight percent of that component based on total weight (100%) of the component, unless otherwise stated. As used herein, the phrase “up to” a quantity of a component means that the quantity is present in the composition up to the specified amount, i.e., greater than zero up to the specified amount. A reference to a component being “optional” or reference to a range having a lower bound of zero weight percent (0 wt. %) or zero parts by hundred (e.g., 0 phr) means that the presence of the component in the composition is optional, i.e., the material is present in an amount or alternatively is not present in the composition.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

It is to be understood that terms such as “top,” “bottom,” “left,” “right,” “front,” “rear,” or the like may refer to an arbitrary frame of reference, rather than to the ordinary gravitational frame of reference. Likewise, spatially relative terms, such as “inner”, “adjacent”, “outer,” “beneath,” “below,” “lower,” “above,” “upper,” or the like, may be used herein for ease of description to describe one element or feature's relationship to another element(s) or feature(s) as illustrated in the figures. Spatially relative terms may be intended to encompass different orientations of the article in use or operation in addition to the orientation depicted in the figures. For example, if the article in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Terms such as first, second, third, etc. may be used herein to describe various elements, components, regions, layers and/or sections, in which it is understood that these elements, components, regions, layers and/or sections should not be limited by these terms unless stated otherwise. In addition, terms such as “first,” “second,” and other numerical terms when used herein do not imply a sequence or order unless clearly indicated by the context. Thus, a first element, component, region, layer or section discussed herein could be termed a second element, component, region, layer or section without departing from the teachings of this disclosure.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

1. A hose comprising:
at least one tubular layer formed from a polyvinyl chloride (PVC) composition comprising:
a) one or more base polymer(s) present in a total amount of 100 phr, the base polymer(s) including one or more PVC polymer(s), the PVC polymer(s) being present in a total amount of at least 70 phr;
b) one or more adipate plasticizer(s) present in a total amount from 50 phr to 85 phr, the adipate plasticizer(s) including one or more dioctyl adipate (DOA) plasticizer(s), the DOA plasticizer(s) constituting a majority by weight of the adipate plasticizer(s); and
c) one or more non-adipate plasticizer(s) in a total amount from 0 phr to 30 phr;
wherein a total plasticizer content of the PVC composition, including (b) the adipate plasticizer(s) and (c) the non-adipate plasticizer(s) when present, is in a range from 70 phr to 110 phr;
wherein a total phr of the PVC composition, including (a) the base polymer(s), (b) the adipate plasticizer(s), and (c) the non-adipate plasticizer(s) when present, is from 170 phr to 210 phr;
wherein the PVC composition does not contain more than 20 phr of one or more other ingredient(s) in total combination, the other ingredient(s), when present, excluding (a) the base polymer(s), (b) the adipate plasticizer(s), and (c) the non-adipate plasticizer(s); and
wherein the PVC composition exhibits cold-temperature embrittlement resistance by not cracking when bent at temperatures of at least −65 F or colder as tested in accordance with ASTM D380.

2. The hose according to claim 1, wherein the PVC composition consists essentially of:
(a) the base polymer(s),
(b) the adipate plasticizer(s),
(c) the non-adipate plasticizer(s) when present,
(d) one or more stabilizer(s), the one or more stabilizer(s) constituting at least part of the total combination of the other ingredient(s); and
(e) optionally, one or more processing aid(s), which when present constitute at least part of the total combination of the other ingredient(s);
wherein the total combination of the other ingredient(s) is less than 10 phr.

3. The hose according to claim 2, wherein the PVC composition consists essentially of:
(a) only the PVC polymer(s) as the base polymer(s) such that the PVC polymer(s) constitute 100 phr of the PVC composition;
(b) only the DOA plasticizer(s) as the adipate plasticizer(s), the DOA plasticizer(s) being present in an amount from 75 phr to 85 phr;
(c) no non-adipate plasticizer(s) present in the PVC composition;
(d) the one or more stabilizer(s) being present in an amount from 5 phr to 10 phr; and
(e) optionally, one or more processing aid(s) present in an amount of less than 1 phr.

4. The hose according to claim 1, wherein:
the total plasticizer content of the PVC composition is from 70 phr to 90 phr; and
the adipate plasticizer(s) are present in a total amount from 65 phr to 85 phr.

5. The hose according to claim 1, wherein:
the adipate plasticizer(s) consist only of DOA plasticizer(s).

6. The hose according to claim 1, wherein:
the force to bend the hose about a 6-inch mandrel at −65 F is less than 18lb/f.

7. The hose according to claim 1, wherein:
the PVC composition has a peak Tan Delta of −20 C or less when tested according to ASTM D5992.

8. The hose according to claim 7, wherein:
the PVC composition has a peak Tan Delta of −30 C or less when tested according to ASTM D5992.

9. The hose according to claim 1, wherein:
the one or more non-adipate plasticizer(s) includes at least one dioctyl terephthalate plasticizer.

10. The hose according to claim 9, wherein:
the at least one dioctyl terephthalate plasticizer is in a total amount from 0 phr to 10 phr.

11. The hose according to claim 1, wherein:
the PVC composition further comprises one or more stabilizer(s), the one or more stabilizer(s) constituting at least part of the total combination of the other ingredient(s), the one or more stabilizer(s) including at least one metal stabilizer and/or at least one epoxidized soybean oil.

12. The hose according to claim 1, wherein the hose is a reinforced hose.

13. The hose according to claim 12, wherein:
the reinforced hose is a multilayer hose having an inner tube layer, a reinforcement layer arranged outwardly of the inner tube layer, and a cover layer arranged outwardly of the reinforcement layer,
the at least one tubular layer formed from the PVC composition forms the inner tube layer and/or the outer cover layer, and
the reinforcement layer comprising PET filaments.

14. The hose according to claim 12, wherein:
the at least one tubular layer is a single tubular layer that defines a lumen of the hose, and
the single tubular layer is reinforced with a continuous strip of PVC helically wound around the single tubular layer, the strip of PVC being more rigid than the PVC forming the singular tubular layer.
